(19) United States
(12) Patent Application Publication
(10) Pub. No.: US 2025/0055764 A1
(43) Pub. Date: Feb. 13, 2025

(54) Management of Communication Network Parameters

(71) Applicant: Telefonaktiebolaget LM Ericsson (publ), Stockholm (SE)

(72) Inventors: Jose Outes Carnero, Torremolinos (ES); Adriano Mendo Mateo, Malaga (ES); Yak Ng Molina, Malaga (ES); Juan Ramiro Moreno, Malaga (ES); Jose Maria Ruiz Aviles, Malaga (ES); Paulo Antonio Moreira Mijares, Malaga (ES); Rakibul Islam Rony, Malaga (ES)

(21) Appl. No.: 18/717,824

(22) PCT Filed: May 20, 2022
(86) PCT No.: PCT/EP2022/063686

§ 371 Date: Jun. 7, 2024

(30) Foreign Application Priority Data
Mar. 18, 2022 (EP) 22382258.6

(51) Int. Cl. H04L 41/16; H04L 41/046; H04L 41/5009; H04W 24/02

(52) U.S. Cl. CPC H04L 41/16; H04L 41/046; H04L 41/5009; H04W 24/02

(57) ABSTRACT

A method (200) is disclosed for orchestrating management of a plurality of operational parameters in an environment of a communication network. Each of the operational parameters is managed by a respective Agent, and at least one performance parameter of the communication network is operable to be impacted by each of the operational parameters. The method comprises obtaining a representation of a state of the environment (210), and generating a prediction, using an ML process and the obtained state representation, of which of the Agents, if allowed to execute within the environment an action selected by the Agent for management of its operational parameter, will result in the greatest increase of a performance measure for the communication network (220). The method further comprises selecting an Agent on the basis of the prediction (230) and initiating execution by the selected Agent of its selected action (240).

### TECHNICAL FIELD

The present disclosure relates to a computer implemented method for orchestrating management of a plurality of operational parameters in an environment of a communication network. The method may be performed by an orchestration node and the present disclosure also relates to an orchestration node and to a computer program product configured, when run on a computer, to carry out a method for orchestrating management of a plurality of operational parameters in an environment of a communication network.

### BACKGROUND

Reinforcement learning (RL) is a popular and powerful tool that may be used to tackle parameter optimization problems in wireless networks. One of the most studied parameters is the Remote Electrical Tilt (RET), which defines the vertical orientation of the antenna of a cell, and whose values may be changed remotely. Modifying RET values involves a trade-off between prioritizing the conflicting Key Performance Indicators (KPIs) of Signal to Interference plus Noise Ratio (SINR) and coverage, in both the Uplink (UL) and the Downlink (DL). Examples of RET optimizers based on RL can be found in WO2021/190772.

Other cell parameters that may be optimized using RL in LTE and 5G networks include PO Nominal PUSCH and Maximum DL transmit power. PO Nominal PUSCH defines the target power per resource block (RB) which a cell expects in the UL communication, from the User Equipment (UE) to the Base Station (BS). By increasing this parameter, the UL SINR in the cell under modification may increase, but the UL SINR in the surrounding cells may concurrently decrease, and vice versa. The dynamics for Maximum DL transmit power are very similar to RET in the DL, as a change in this parameter can improve the cell coverage at the expense of a DL SINR reduction in the neighboring cells, and vice versa. Additionally, a reduction in this value results in energy saving, and headroom increase for other carrier and/or technologies. It has been proposed to optimize Maximum DL transmit power using RL agents that interact with a digital twin instead of the real network, enabling the system to obtain optimal values in just one iteration with the real network.

These three examples of parameters have in common the fact that a change in parameter value in a given cell also impacts the neighboring cells. In order to address this issue, it has been proposed to coordinate the decisions made by multiple different per-cell agents with the aim of optimizing a certain parameter per cell. However, many network KPIs may be influenced by multiple different cell parameters. For example, RET and maximum DL transmit power can both impact SINR and coverage, meaning that systems coordinating optimization of a single cell parameter with respect to given network KPIs may still not be accounting for all cell management actions that impact those KPIs.

### SUMMARY

It is an aim of the present disclosure to provide methods, an orchestration node, and a computer program product which at least partially address one or more of the challenges mentioned above. It is a further aim of the present disclosure to provide methods, an orchestration node and a computer program product which facilitate management of operational parameters in a communication network environment to enable optimisation of a network performance parameter for the environment, the network performance parameter being impacted by the operational parameters to be managed.

According to a first aspect of the present disclosure, there is provided a computer implemented method for orchestrating management of a plurality of operational parameters in an environment of a communication network, wherein each of the operational parameters is managed by a respective Agent, and wherein at least one performance parameter of the communication network is operable to be impacted by each of the operational parameters. The method, performed by an orchestration node, comprises obtaining a representation of a state of the environment and generating a prediction, using a Machine Learning (ML) process and the obtained state representation, of which of the Agents, if allowed to execute within the environment an action selected by the Agent for management of its operational parameter, will result in the greatest increase of a performance measure for the communication network. The method further comprises selecting an Agent on the basis of the prediction, and initiating execution by the selected Agent of its selected action.

According to another aspect of the present disclosure, there is provided a computer program product comprising a computer readable non-transitory medium, the computer readable medium having computer readable code embodied therein, the computer readable code being configured such that, on execution by a suitable computer or processor, the computer or processor is caused to perform a method according to any one of the aspects or examples of the present disclosure.

According to another aspect of the present disclosure, there is provided an orchestration node for orchestrating management of a plurality of operational parameters in an environment of a communication network, wherein each of the operational parameters is managed by a respective Agent, and wherein at least one performance parameter of the communication network is operable to be impacted by each of the operational parameters. The orchestration node comprises processing circuitry configured to cause the orchestration node to obtain a representation of a state of the environment, and generate a prediction, using an ML process and the obtained state representation, of which of the Agents, if allowed to execute within the environment an action selected by the Agent for management of its operational parameter, will result in the greatest increase of a performance measure for the communication network. The processing circuitry is further configured to cause the orchestration node to select an Agent on the basis of the prediction, and initiate execution by the selected Agent of its selected action.

According to another aspect of the present disclosure, there is provided an orchestration node for orchestrating management of a plurality of operational parameters in an environment of a communication network, wherein each of the operational parameters is managed by a respective Agent, and wherein at least one performance parameter of the communication network is operable to be impacted by each of the operational parameters. The orchestration node is configured to obtain a representation of a state of the environment, and generate a prediction, using a Machine Learning, ML, process and the obtained state representation, of which of the Agents, if allowed to execute within the environment an action selected by the Agent for management of its operational parameter, will result in the greatest increase of a performance measure for the communication network. The orchestration node is further configured to select an Agent on the basis of the prediction, and initiate execution by the selected Agent of its selected action.

Aspects of the present disclosure thus provide methods and nodes that provide automatic coordination of multiple optimization agents in a communication network environment, each agent managing a respective operational parameter, and each parameter impacting at least network KPI in common. The methods and nodes ensure that at each iteration, a selected agent is able to execute its action, with the overall goal of maximising increase of a performance measure for the managed communication network environment.

### BRIEF DESCRIPTION OF THE DRAWINGS

For a better understanding of the present disclosure, and to show more clearly how it may be carried into effect, reference will now be made, by way of example, to the following drawings in which:

FIG. 1 illustrates the applied strategy during an experiment in which coordination between different agents managing cell parameters in a network was performed manually by expert engineers;

FIG. 2 is a flow chart illustrating process steps in a method for orchestrating management of a plurality of operational parameters in an environment of a communication network;

FIG. 3 is a schematic illustration of an architecture in which examples of the method of FIG. 2 may be carried out;

FIGS. 4a to 4d show flow charts illustrating another example of a method for orchestrating management of a plurality of operational parameters in an environment of a communication network;

FIG. 5 is a block diagram illustrating functional modules in an example orchestration node;

FIG. 6 is a block diagram illustrating functional modules in another example orchestration node;

FIG. 7 illustrates an example implementation architecture for implementing example methods disclosed herein;

FIGS. 8 and 9 illustrate different examples of orchestration node;

FIG. 10 illustrates another example implementation architecture for implementing example methods disclosed herein;

FIG. 11 is a block diagram illustrating functional modules in an example orchestration node;

FIG. 12 is a block diagram illustrating functional modules in an example score estimator;

FIG. 13 illustrates implementation of an orchestration node in an O-RAN architecture;

FIGS. 14 to 16 illustrate comparative results of an example implementation of methods disclosed herein.

### DETAILED DESCRIPTION

Examples of the present disclosure propose an automated method for orchestrating managing multiple different operational parameters to optimise a particular network performance parameter, when each of the managed operational parameters is operable to impact the performance parameter.

The Ericsson Mobility Report released in June 2021 (https://www.ericsson.com/49ced5/assets/local/mobility-report/documents/2021/ai enhancing-customer-experience.pdf) describes, in “AI: enhancing customer experience in a complex 5G world”, a manual optimization experiment on a live network in which two different optimizers based on Reinforcement Leaning (RL) were manually combined to obtain promising results. The first optimizer executed in this activity was an RL agent for RET tuning based on WO2021190772 and pretrained with a simulator as a digital twin, which typically requires 5 to 20 iterations to converge. The second optimizer in the activity was an RL agent for maximum DL transmit power optimization, which does not require any iterations with the real network, since all iterations are carried out by interacting with a network emulator, which works as a digital twin. This is a one-shot optimizer that directly provides the final parameter settings to be implemented in the real network.

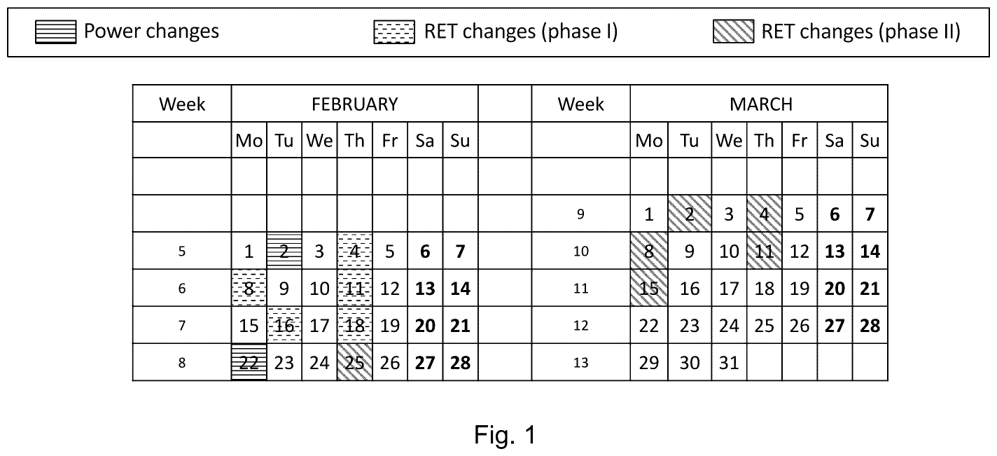

In the described experiment, the coordination between different agents was performed manually by the expert engineers who ran the trial. At every iteration, the engineers took a decision on which agent to use based on aggregated KPIs from the cell cluster under consideration. FIG. 1 illustrates the coordination achieved by the engineers, with the DL power agent being selected on the 2^{nd} and 22^{nd} February, and RET agents being selected on the remaining highlighted days. Each intervention of the DL power agent sought to reduce the DL power, with any attendant performance degradation addressed by the subsequent actions of the RET optimization agent.

While the above described experiment achieved promising results, it is entirely dependent on domain engineers performing manual selection of agents according to their expert assessment of network KPIs. This solution is clearly extremely limiting, in terms of costs and the availability of suitable domain experts, as well as being extremely difficult to scale. Even with availability of suitable engineers, considering the impact of the combination of managed parameters (DL power and RET in the example experiment) is a not trivial task, and suboptimal decisions may be taken if the engineers do not have enough expertise. Commercialization of a solution is also highly challenging when manual orchestration of one or more digital agents is required.

The present disclosure proposes a method and orchestration node that coordinate two or more optimization agents by taking a decision as to which agent to use at each iteration. The optimization agents may operate at a first level, for example a cell level, while the orchestration node operates at a second level, for example a cluster level. In another example, the optimization agents may operate at cluster level, with the orchestration node operating over a plurality of clusters, or a larger segment of the network. As is discussed in greater detail below, two approaches are proposed herein for the operation of the orchestration node.

In a first approach, the orchestrator node may implement a deep Q-learning RL agent capable of learning which operational parameter optimization agent is the most suitable to use given the state of the network. A light state definition may be used to accelerate the learning process, for example containing the action applied in the previous iteration plus the common KPIs impacted by all optimization agents, aggregated at cluster level. The reward may be a score consisting of a weighted sum of the improvements in the common KPIs aggregated at cluster level. In some examples, weights may be configured prioritize one or more KPIs over the rest. One action may be defined per optimization agent.

In some examples of the first approach, a Recurrent Neural Network (RNN) may be used to accumulate the acquired knowledge from a number of previous observations and determine the best next action at every iteration. The use of an RNN may enable consideration of a number of previous states and their associated scores when estimating the best next action at a given iteration. In other examples of the first approach, a Deep Neural Network (DNN) may be used instead of an RNN, and the KPIs and actions associated with a predefined number of previous steps may be included as part of the state definition. In still further examples using a DNN, actions as well as the mean and standard deviation of the KPIs associated with a predefined number of previous steps may be included as part of the state definition.

In a second approach, the orchestrator node may estimate a score of every optimization agent independently using Supervised Learning (SL), and select the agent with the highest score value. The score may be equivalent to the reward defined for the first approach, that is the score may comprise a weighted sum of the improvements in the common KPIs aggregated at cluster level. In some examples, a dedicated RNN may be used to estimate the score for each optimization agent, with input features corresponding to those forming the state as defined for the first approach. It will be appreciated that differs from the first approach, in which a single RNN may be used to reward values for all optimization agents. In other examples, a DNN may be used instead an RNN, considering the KPIs and actions associated with a predefined number of previous steps as input features. In still further examples using a DNN, actions as well as the mean and standard deviation of the KPIs associated with a predefined number of previous steps may be included as input features.

In one example of the second approach, one or more of the score estimations from the orchestration node may be replaced with an estimation provided by the relevant optimization agent. An agent may have the capability to provide such an estimation, for example if the agent uses a digital twin.

In either approach, KPI values for preceding steps may be set with predetermined values during initial iterations, when previous states and measured values of KPIs may not be available. For example, negative values of KPIs may be used for preceding steps, with all measured instances of KPI values being normalized to be greater than zero. In this manner, the orchestration agent may quickly learn to distinguish between measured values and simulated values for use in initial iterations.

In a further example applicable to either approach, certain preconditions may be imposed for the selection of agents, so as to ensure a minimum or maximum number of consecutive selections of a particular agent in consecutive iterations of the method. For example, if a particular agent requires several iterations to converge, this may be enforced via a precondition, configuration setting or as a hyperparameter. It may also be advantageous to prevent a certain agent from running more than once consecutively, and/or to enforce a minimum number of iterations before it can be selected again. Another option may be to enforce an absolute or a change (delta) threshold value for one or more KPIs before a certain agent may become eligible for selection.

In some examples, initial learning for the disclosed methods and orchestration node may be accelerated offline using a simulator, and/or pretraining of the orchestration node may be carried out using recorded real network data from a period of operation in which orchestration of parameter management was carried out manually.

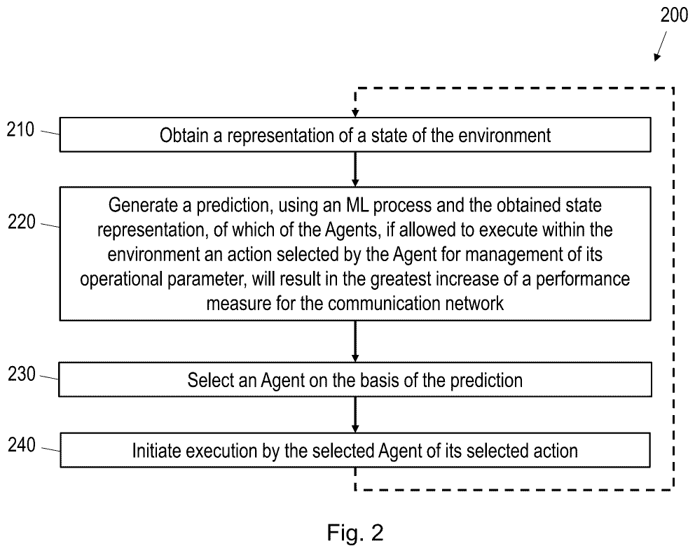

FIG. 2 is a flow chart illustrating process steps in a computer implemented method 200 for orchestrating management of a plurality of operational parameters in an environment of a communication network, wherein each of the operational parameters is managed by a respective Agent, and wherein at least one performance parameter of the communication network is operable to be impacted by each of the operational parameters. The environment may comprise a network cell, a cluster of substantially contiguous network cells, a plurality of such clusters, etc.

For the purpose of the present disclosure, an operational parameter is one that can be configured by the network, while a performance parameter is one that is measured within the network, or calculated on the basis of such measurements, and is representative in some way of network performance. Performance parameters may comprise combinations of multiple measurements and include within their scope network KPIs such as coverage, quality etc. An operational parameter is operable to impact a performance parameter if a change in configuration of the operational parameter is able to cause a change in the measured performance parameter that is above a threshold value (which may for example be a percentage change threshold). The threshold value may be selected to identify those operational parameters for which changes in a configured value can have an impact on a performance parameter that is significant from an operational point of view, and distinguish such operational parameters from those whose values may only have a small, and for the perspective of network operations, negligible impact on a given performance parameter.

Also for the purpose of the present disclosure, an Agent comprises a physical or virtual entity that is operable to implement a policy for the selection of actions on the basis of an environment state. Examples of a physical entity may include a computer system, computing device, server etc. Examples of a virtual entity may include a piece of software or computer program, a code fragment operable to implement a computer program, a virtualised function, or any other logical entity. A virtual entity may for example be instantiated in a cloud, edge cloud or fog deployment. As discussed in further detail below, an Agent may be operable to implement a management policy for the selection of actions to be executed in an environment on the basis of an observation of the environment, and to use feedback for training during deployment in order to continually update its management policy and improve the quality of actions selected. An Agent may for example be operable to implement a Reinforcement Learning model for selecting actions to be executed in an environment. Examples of RL models may include Q-learning, State-Action-Reward-State-Action (SARSA), Deep Q Network, Policy Gradient, Actor-Critic, Asynchronous Advantage Actor-Critic (A3C), etc.

The method 200 is performed by an orchestration node, which may comprise a physical or virtual node, and may be implemented in a computer system, computing device or server apparatus and/or in a virtualized environment, for example in a cloud, edge cloud or fog deployment. Examples of a virtual node may include a piece of software or computer program, a code fragment operable to implement a computer program, a virtualised function, or any other logical entity. The orchestration node may for example be implemented in a core network of the communication network, and may be implemented in the Operation Support System (OSS). The orchestration node may be implemented in an Orchestration And Management (OAM) system or in a Service Management and Orchestration (SMO) system. In other examples, the orchestration node may be implemented in a Radio Access node, which itself may comprise a physical node and/or a virtualized network function that is operable to exchange wireless signals. In some examples, a Radio Access node may comprise a base station node such as a NodeB, eNodeB, gNodeB, or any future implementation of this functionality. The orchestration node may be implemented as a function in an Open Radio Access Network (ORAN) or Virtualised Radio Access Network (vRAN). The orchestration node may encompass multiple logical entities, as discussed in greater detail below, and may for example comprise a Virtualised Network Function (VNF).

Referring to FIG. 2, the method 200 comprises, in a first step 210, obtaining a representation of a state of the environment. The method then comprises, in step 220, generating a prediction, using a Machine Learning (ML) process and the obtained state representation, of which of the Agents, if allowed to execute within the environment an action selected by the Agent for management of its operational parameter, will result in the greatest increase of a performance measure for the communication network. In step 230, the method comprises selecting an Agent on the basis of the prediction before, in step 240, initiating execution by the selected Agent of its selected action.

The performance measure of the method 200 may comprise a function of performance parameters of the communication network, including the at least one performance parameter of the communication network that is operable to be impacted by each of the operational parameters. Example implementations of a performance measure include the reward and score discussed above with respect to the different approaches to implementation of the orchestration node according to the present disclosure.

For the purposes of the present disclosure the state of the environment comprises the current situation, condition, and/or circumstances of the environment, and may in some examples include its configuration, as well as the presence and position (within physical or radio space) of entities within the environment, requests currently being made of the environment, availability and/or requirements for resources within the environment, condition of such resources, etc. The state of the environment may be represented by environment observations, which may include values of configurable parameters for the environment and/or its contents, values of measurable parameters for the environment and/or its contents, demands being made upon the environment, entities present within the environment, etc. In some examples, the state of the environment may also be represented by an aggregation of previous reward values of individual Agents. In some examples, the state of the environment may be represented using values of network performance parameters for the environment, including, inter alia, those that are considered as part of the performance measure.

For the purposes of the present disclosure, it will be appreciated that an ML model is considered to comprise the output of a Machine Learning algorithm or process, wherein an ML process comprises instructions through which data may be used in a training procedure to generate a model artefact for performing a given task, or for representing a real world process or system. An ML model is the model artefact that is created by such a training procedure, and which comprises the computational architecture that performs the task.

In some examples, the steps of the method 200 may be repeated at each instance of a configurable time window, so as to ensure a sequential combination of management of different operational parameters, which combination is optimal with respect to the performance measure.

The method 200 addresses the problem of independent management of parameters that impact the same network KPIs. The method 200 provides an automated process for orchestrating sequential implementation of actions selected by agents managing different parameters in such a way that a performance measure for the network is optimized. The precise definition of the performance measure, including for example the weights of a weighted combination of network performance parameters, may be selected according to priorities for network optimization.

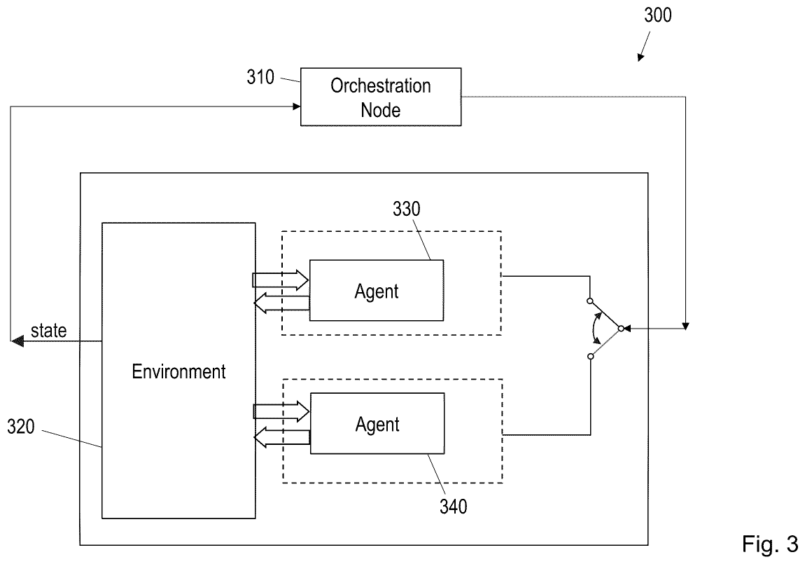

FIG. 3 is a schematic illustration of an architecture 300 in which examples of the method 200, performed by an orchestration node 310, may be carried out. Referring to FIG. 3, the architecture comprises an environment 320 of a communication network, and two Agents, 330, 340, each interacting with the environment 320 to manage a specific operational parameter. Each agent selects an action to be carryout out in the environment on the basis of information received from the environment. On the basis of environment state representation 350 received from the environment, the orchestration node 310 selects which of the agents 330, 340 should execute its selected action on the environment at each iteration.

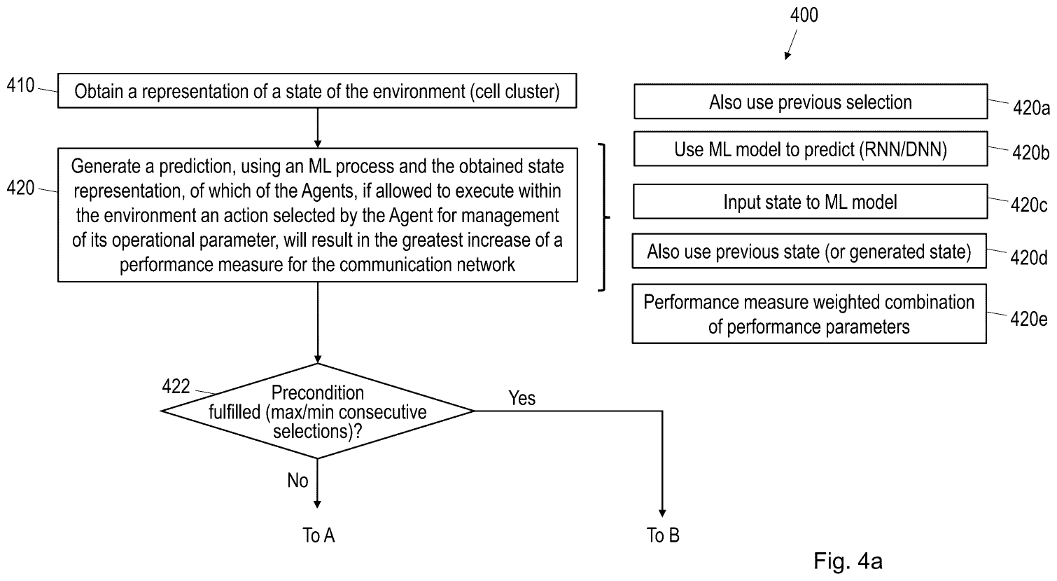

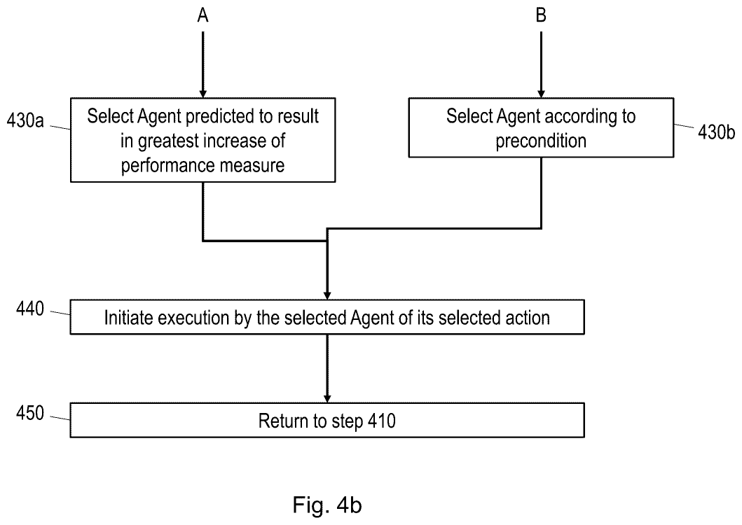

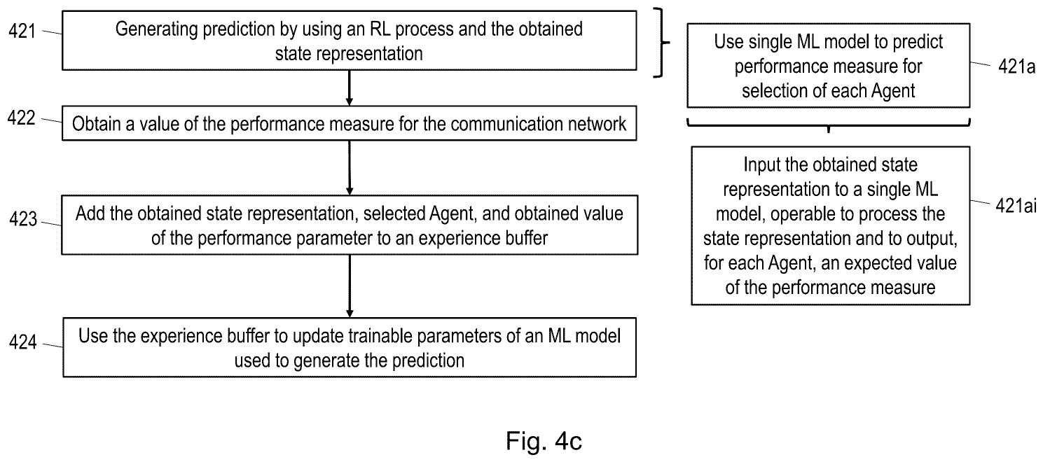

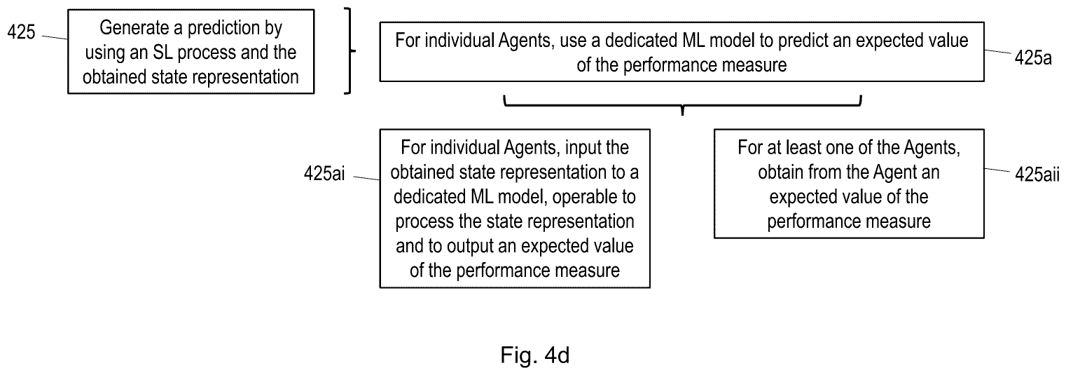

FIGS. 4a to 4d show flow charts illustrating another example of a method 400 for orchestrating management of a plurality of operational parameters in an environment of a communication network, wherein each of the operational parameters is managed by a respective Agent, and wherein at least one performance parameter of the communication network is operable to be impacted by each of the operational parameters. As for the method 300 discussed above, the method 400 is performed by an orchestration node, and the above discussion of orchestration node, Agents, parameters etc., provided in connection with the method 200, applies equally to the method 400. The method 400 illustrates examples of how the steps of the method 200 may be implemented and supplemented to provide the above discussed and additional functionality.

The environment may comprise a plurality of cells of the communication network, for example a cluster of cells, which may be substantially contiguous, or a group of such clusters. The plurality of performance parameters may comprise, inter alia, Remote Electrical Tilt, maximum Downlink Transmission power, PO Nominal PUSCH, etc. In some examples of the method 400, at least one of the operational parameters may be managed at cell level, each cell having a dedicated managing Agent for the parameter within the cell. This may be the case for example for RET, which may be managed via Agents that are specific to individual cells. In further examples, at least one of the operational parameters may be managed at environment level. This may be the case for example for maximum DL transmission power, which may be managed and set at a cluster level.

Referring initially to FIG. 4a, in a first step 410, the orchestration node obtains a representation of a state of the environment. As discussed above, this may comprise values of a range of parameters characterizing the current configuration situation of the environment, and may include for example values of one or more network performance parameters, including the one or more performance parameter(s) operable to be impacted by the managed operational parameters. The state representation may also include actions previously executed in the environment, an identifier of the agent selected to execute its action in preceding iterations, state representations from previous iterations of the method, etc. In some examples, the state of the environment may also be represented by an aggregation of previous reward values of individual Agents.

In step 420, the orchestration node generates a prediction, using an ML process and the obtained state representation, of which of the Agents, if allowed to execute within the environment an action selected by the Agent for management of its operational parameter, will result in the greatest increase of a performance measure for the communication network. As discussed above, two approaches may be considered for implementing this step, via Reinforcement Learning (RL) or via Supervised Learning (SL). Each of these approaches is discussed in greater detail with reference to FIGS. 4c and 4d below. However, both approaches may have a number of features in common, and these are illustrated in FIG. 4a.

In some examples, generating a prediction in step 420 may further comprise using an indication of which of the Agents was selected during a previous iteration of the method, as illustrated at step 420a and discussed above. This indication may be taken account as part of the state representation or may for example be used to assess whether a precondition for selection is fulfilled, as discussed below. A previous iteration may comprise the immediately preceding iteration, and/or may comprise up to a threshold number of preceding iterations, for example, generating a prediction may be based on an indication of selected agent for the preceding 2, 3, 4, 5 or more iterations of the method, as well as the state representation for the present iteration, obtained in step 410.

In some examples, generating a prediction may comprise using an ML model to predict, for each of the Agents, an expected value of the performance measure if the Agent is allowed to execute within the environment an action selected by the Agent for management of its operational parameter. The model may comprise one or more RNN(s) or DNN(s). In some examples, the expected values may comprise the q values for the different Agents, or the scores for the different agents, according to the different RL and SL options introduced above and discussed in greater detail below.

In further examples, as illustrated at 420c, generating a prediction may comprise, for an Agent, inputting the obtained state representation to an ML model, wherein the ML model is operable to process the state representation in accordance with current values of trainable parameters of the ML model, and to output an expected value of the performance measure if the Agent is allowed to execute within the environment an action selected by the Agent for management of its operational parameter. The ML model may be the same ML model for all Agents (first, RL, approach discussed above), or a dedicated model per agent (second, SL, approach discussed above).

In further examples, generating a prediction further comprises using a representation of a state of the environment obtained during a previous iteration of the method, as illustrated at 420d. As for the indication of previously selected Agent, a previous iteration may comprise the immediately preceding iteration, and/or may comprise up to a threshold number of preceding iterations, for example, generating a prediction may be based on a state representation for the preceding 2, 3, 4, 5 or more iterations of the method, as well as the state representation for the present iteration, obtained in step 410. In the case of an RNN, this step of using a previous state representation may be achieved by the model itself, whereas for a DNN, the previous representations may be included in the state representation input to the model. For example, in implementations of the method 400 in which generating a prediction comprises using a DNN to predict, for each of the Agents, an expected value of the performance measure if the Agent is allowed to execute within the environment an action selected by the Agent for management of its operational parameter, using the DNN may comprise inputting to the DNN the obtained state representation and a state representation obtained during a previous iteration of the method. As discussed above, “a previous iteration” may include multiple previous representations, for example at least the representations from the preceding 2, 3, 4, 5 or more iterations.

As illustrated at step 420d, if a representation of a state of the environment obtained during a previous iteration of the method is not available, the generating a prediction may comprise generating an initial state representation for use in generating the prediction. This may for example comprise setting values for parameters of the initial state representation to be outside a normalized envelope for values of such parameters in the obtained state representation. For example, if obtained values for parameters in the state representation are normalized to be positive, then the initial values may be set to be negative, as discussed above.

As illustrated at 420e, in some examples of the method 400, the performance measure may comprise a weighted combination of performance parameters for the communication network. The at least one performance measure that is impacted by each of the operational parameters being managed may be included in the combination. The weights applied to different performance parameters including in the performance measure may be selected according to operational priorities for the communication network environment, as discussed in further detail below with reference to example implementations of the method.

Referring still to FIG. 4a, after generating the prediction as to which Agent, if selected, will result in the greatest increase if the performance measure for the communication network, the orchestration node then checks in step 422 whether a precondition is fulfilled for a selection other than that suggested by the prediction.

The precondition sets out circumstances under which a rules based Agent selection should be made. There may be a range of different circumstances under which this is appropriate, including for example:
a maximum or minimum limit on the number of times an Agent may be selected consecutively;
a maximum number of iterations before an agent can be selected again;
a threshold value or change (increase or decrease) of a KPI that should be observed for a particular agent to be eligible for selection (absolute threshold or delta threshold).

In some examples consecutive selection of an Agent that is capable of one-shot inference (such as the power Agent using a digital twin in the example discussed above) may be prevented, and/or a minimum limit of several consecutive selections may be imposed for an Agent that requires multiple inferences to converge to an optimal solution (such as the RET Agent of the example discussed above). If a precondition is fulfilled (Yes at step 422), then the orchestration node selects an Agent in compliance with the precondition, as illustrated at step 430b in FIG. 4b. Depending upon the nature of the precondition, the selection may be determined exclusively by the precondition, or the precondition may exclude from consideration one or more Agents, with the selection from the remaining agents being based on the prediction generated at step 420. The following example scenarios illustrate a range of options for interworking of the precondition and prediction based selection:

1) A precondition preventing Agent 1 from being selected consecutively.
1a) Agent 1 was selected in the immediately preceding iteration and there are only two Agents being orchestrated—select other Agent in present iteration
1b) Agent 1 was selected in the immediately preceding iteration and there are three or more Agents being orchestrated—select from among the remaining Agents according to the prediction generated at step 420
1c) Agent 1 was not selected in the immediately preceding iteration—select from among all Agents being orchestrated according to the prediction generated at step 420.

2) A precondition ensuring that Agent 2 is selected a minimum of X times.
2a) Agent 2 was not selected in the immediately preceding iteration—select from among all Agents being orchestrated according to the prediction generated at step 420.
2b) Agent 2 was selected in the immediately preceding iteration—if the immediately preceding iteration was the Y'th consecutive selection of Agent 2 with Y equal to or greater than X, then select from among all Agents being orchestrated according to the prediction generated at step 420, otherwise, select Agent 2.

It will be appreciated that the above examples are merely for the purpose of illustration, and other examples may be envisaged, for example in which a hierarchy of checks is performed, on preceding iteration Agent selection, KPI change or absolute value, number of iterations since a previous Agent selection, etc. Such checks may enforce a selection or may remove an Agent from contention for a selection on the basis of the prediction generated at step 420, according to the nature of the precondition.

Referring now to FIG. 4b, if the precondition check at step 422 determines that at least one aspect of a precondition is fulfilled, then the orchestration node proceeds to select an Agent according to the precondition at step 430b. As discussed above, this may also imply consideration of the prediction generated at step 420, depending on the nature of the precondition. If no precondition is fulfilled for a selection based on factors other than the prediction at step 420, then the orchestration node proceeds at step 430a to selecting an Agent on the basis of the prediction by selecting the Agent predicted to result in the greatest increase of the performance measure.

In some examples, the orchestration node may impose additional limitations or constraints upon selection of Agents, for example according to operational priorities determined by a network administrator. For example, and considering a scenario in which the environment being managed comprises a plurality of network cells, and at least one of the Agents being orchestrated manages operational parameters at cell level, the orchestration node may in some examples always select the same Agent for different cells at the same iteration of the method 400, ensuring that the same operational parameter is managed for all cells at a given iteration step. In other examples, the orchestration node may be operable to select one Agent for some cells of the environment, and a different Agent for other cells, so implementing either different cell level operational parameter monument at a given iteration of the method 400, or a mix of cell level and environment level operational parameter management at a given iteration of the method 400.

Following selection of an Agent at step 430a or 430b, the orchestration node then initiates execution by the selected Agent of its selected action. This may for example comprise sending a message to the selected Agent, or in some manner facilitating access by the selected Agent to the environment in order for the Agent to be able to carry out its selected action in the environment. The action selected by the Agent will relate to the operational parameter being managed by the Agent, and so may be an antenna tilt angle adjustment in the case of a RET Agent, or a power setting, in the case of a DL transmission power agent, etc.

At step 450, following initiation of execution by the selected Agent of its selected action, the orchestration node returns to step 410 and obtains a new representation of a state of the environment, which may include measured values of the change in the performance measure for the environment.

As discussed above, two approaches may be considered for implementing the step 420 of generating a prediction, using an ML process and the obtained state representation, of which of the Agents, if allowed to execute within the environment an action selected by the Agent for management of its operational parameter, will result in the greatest increase of a performance measure for the communication network. These approaches are via Reinforcement Learning (RL) or via Supervised Learning (SL). Each of these approaches is discussed in greater detail with reference to FIGS. 4c and 4d below. Steps that may be performed in order to carry out the prediction at 420 using an RL approach are illustrated in FIG. 4c, and steps that may be performed in order to carry out the prediction at 420 using an SL approach are illustrated in FIG. 4d.

Referring first to FIG. 4c, according to some examples, generating a prediction may comprise using an RL process and the obtained state representation to generate the prediction, at step 421. Deep Q learning is an example of an RL process that may be used. Expected SARSA is another example.

As illustrated at 421a, using an RL process may comprise using a single ML model to predict, in a single inference and for each of the Agents, an expected value of the performance measure if the Agent is allowed to execute within the environment an action selected by the Agent for management of its operational parameter. This may be achieved by, at step 421ai, inputting the obtained state representation to a single ML model, wherein the ML model is operable to process the state representation in accordance with current values of trainable parameters of the ML model, and to output, for each Agent, an expected value of the performance measure if the Agent is allowed to execute within the environment an action selected by the Agent for management of its operational parameter.

In the case of a method 400 in which the RL approach is used, the method 400 may further comprise the steps 422 to 424 illustrated in FIG. 4c. At step 422, the orchestration node may further obtain a value of the performance measure for the communication network, for example following execution by the selected Agent of its selected action. The orchestration node may then add the obtained state representation, selected Agent, and obtained value of the performance parameter to an experience buffer at step 423, and use the experience buffer to update trainable parameters of the ML model used to generate the prediction.

In some examples, the orchestration node and Agents may interact with a simulated environment during an initial learning phase of the process. The orchestration node may for example use an epsilon greedy algorithm to explore the simulated environment and perform initial refinement of the prediction model, before interacting with a live network. In this manner, while continued refinement of the prediction model may take place during interaction with the live network, the initial environment learning may be performed on the simulated network. Such initial learning necessarily involves a degree of exploration of the state action space for the orchestration node (in which the action is the action of the orchestration node, that is the selection of which Agent to initiate). During this exploration undesirable selections may be made resulting in significant degradation of the performance measure. Carrying out this exploration on the simulated network ensures that such undesirable outcomes are minimized in the live network.

Referring now to FIG. 4d, according to some examples, generating a prediction may comprise using an SL process and the obtained state representation to generate the prediction, at step 425.

As illustrated at 425a, using an RL process may comprise, for individual Agents, using a dedicated ML model to predict an expected value of the performance measure if the Agent is allowed to execute within the environment an action selected by the Agent for management of its operational parameter. This may be implemented for example by, at step 425a and for individual Agents, inputting the obtained state representation to a dedicated ML model, wherein the ML model is operable to process the state representation in accordance with current values of trainable parameters of the ML model, and to output an expected value of the performance measure if the Agent is allowed to execute within the environment an action selected by the Agent for management of its operational parameter.

In some examples, the individual ML models may be trained using a training data set collected during management of the operational parameters that is orchestrated by manual intervention from network administrators, rules-based orchestration, or any other method.

In some examples, as illustrated in step 425aii, for at least one of the Agents, generating a prediction may comprise obtaining from the Agent an expected value of the performance measure if the Agent is allowed to execute within the environment an action selected by the Agent for management of its operational parameter. Such a prediction may not be available from all Agents, but in the case for example of an Agent that makes use a digital twin, the generation of such a prediction may form part of the Agent's normal operation, and so provision by the Agent of its own prediction may be feasible.

As discussed above, the methods 200 and 400 may be performed by an orchestration node, and the present disclosure provides an orchestration node that is adapted to perform any or all of the steps of the above discussed methods. The orchestration node may comprise a physical node such as a computing device, server etc., or may comprise a virtual node. A virtual node may comprise any logical entity, such as a Virtualized Network Function (VNF) which may itself be running in a cloud, edge cloud or fog deployment. The orchestration node may be operable to be instantiated in a range of different physical and/or logical entities, as discussed above with reference to FIG. 2.

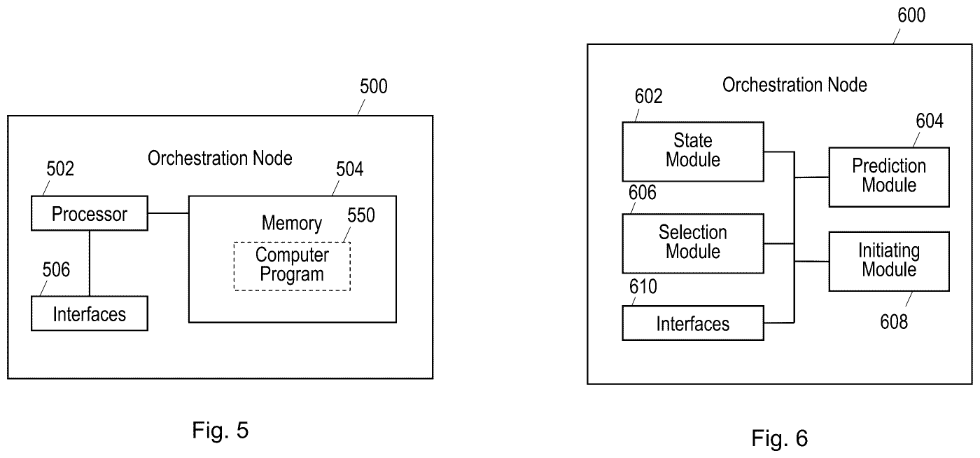

FIG. 5 is a block diagram illustrating an example orchestration node 500 which may implement the method 200 and/or 400, as illustrated in FIGS. 2 and 4a to 4d, according to examples of the present disclosure, for example on receipt of suitable instructions from a computer program 550. Referring to FIG. 5 the orchestration node 500 comprises a processor or processing circuitry 502, and may comprise a memory 504 and interfaces 506. The processing circuitry 502 is operable to perform some or all of the steps of the method 200 and/or 400 as discussed above with reference to FIGS. 2 and 4a to 4d. The memory 504 may contain instructions executable by the processing circuitry 502 such that the orchestration node 500 is operable to perform some or all of the steps of the method 200 and/or 400, as illustrated in FIGS. 2 and 4a to 4d. The instructions may also include instructions for executing one or more telecommunications and/or data communications protocols. The instructions may be stored in the form of the computer program 550. In some examples, the processor or processing circuitry 502 may include one or more microprocessors or microcontrollers, as well as other digital hardware, which may include digital signal processors (DSPs), special-purpose digital logic, etc. The processor or processing circuitry 502 may be implemented by any type of integrated circuit, such as an Application Specific Integrated Circuit (ASIC), Field Programmable Gate Array (FPGA) etc. The memory 504 may include one or several types of memory suitable for the processor, such as read-only memory (ROM), random-access memory, cache memory, flash memory devices, optical storage devices, solid state disk, hard disk drive, etc.

FIG. 6 illustrates functional modules in another example of orchestration node 600 which may execute examples of the methods 200 and/or 400 of the present disclosure, for example according to computer readable instructions received from a computer program. It will be understood that the modules illustrated in FIG. 6 are functional sub-modules, and may be realized in any appropriate combination of hardware and/or software. The modules may comprise one or more processors and may be integrated to any degree.

Referring to FIG. 6, the orchestration node 600 is for orchestrating management of a plurality of operational parameters in an environment of a communication network, wherein each of the operational parameters is managed by a respective Agent, and wherein at least one performance parameter of the communication network is operable to be impacted by each of the operational parameters. The orchestration node 600 comprises a state module 602 for obtaining a representation of a state of the environment. The orchestration node further comprises a prediction module 604 for generating a prediction, using an ML process and the obtained state representation, of which of the Agents, if allowed to execute within the environment an action selected by the Agent for management of its operational parameter, will result in the greatest increase of a performance measure for the communication network. The orchestration node 600 further comprises a selection module 606 for selecting an Agent on the basis of the prediction, and an initiating module 608 for initiating execution by the selected Agent of its selected action. The orchestration node 600 may further comprise interfaces 610, which may be operable to facilitate communication with one or more Agents, and/or with other nodes or modules, over suitable communication channels.

FIGS. 2 to 4d discussed above provide an overview of methods which may be performed according to different examples of the present disclosure. These methods may be performed by an orchestration node as illustrated in FIGS. 5 and 6. The methods automatic coordinate of two or more optimization Agents, which Agents may themselves be based on RL, and which Agents tune different cell parameters that have an impact on similar KPIs. The methods seek to identify and select at each iteration the most suitable optimization agent to be allowed to interact with the managed environment. There now follows a detailed discussion of how different process steps illustrated in FIGS. 2 to 4d and discussed above may be implemented. The functionality and implementation detail described below is discussed with reference to the modules of FIGS. 5 and 6 performing examples of the methods 200 and/or 400, substantially as described above.

The following description of example implementations of the methods disclosed herein focuses on the particular case of coordinating two specific optimization agents in an environment comprising a cluster of cells. It will be appreciated however that this is merely for the purpose of illustration, and coordination of any other two or more Agents that optimize operational parameters impacting at least one performance parameter in common in a communication network such as a wireless cellular network.

The particular optimization Agents considered in the following description are:
RET optimization agent: an RL agent for RET optimization based on WO2021190772 and pretrained a network simulator as a digital twin, which typically requires 5 to 20 iterations to converge. Once pretrained, this agent is able to interact with a real network iteratively, proposing incremental RET changes until it converges.
Power optimization agent: an RL agent for maximum DL transmit power optimization, which does not require any iterations with the real network, as all iterations are carried out by interacting with a network emulator, which works as a digital twin. This is a one-shot optimizer that provides the final parameter settings directly, for implementation in the live network. In this case this is possible because the digital twin mimics the behavior of the live network when changes in the maximum DL transmit power are applied, predicting the reward and the new state with high accuracy.

It will be appreciated that the above agents were also used in the manual orchestration experiment described above, allowing for performance comparison of the manual orchestration with methods according to the present disclosure, as discussed in greater detail below. The variation of both parameters impacts the same KPIs for the DL, which in this case are the quality KPIs (for example DL user throughput and DL SINR) and coverage. In addition, changing the maximum DL transmit power has a direct impact on the energy consumption. This impact is not so clearly seen when changing RET, although RET adjustments may also impact energy consumption to some degree. It will be appreciated that the variation of RET and power also impact some KPIs in the Uplink (UL). The following discussion focuses on the DL performance, although additional KPIs for UL could be added to the state and reward definitions set out below.

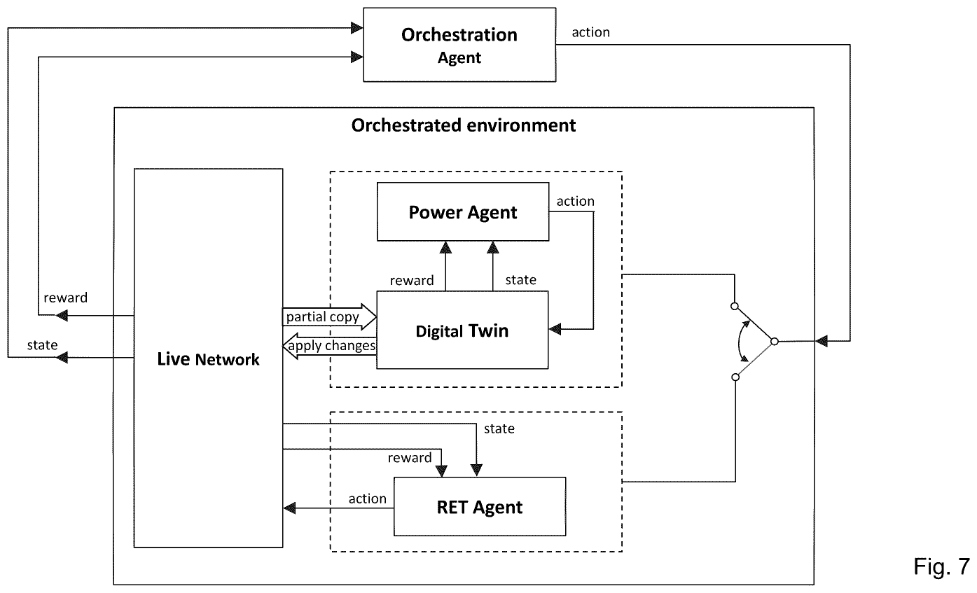

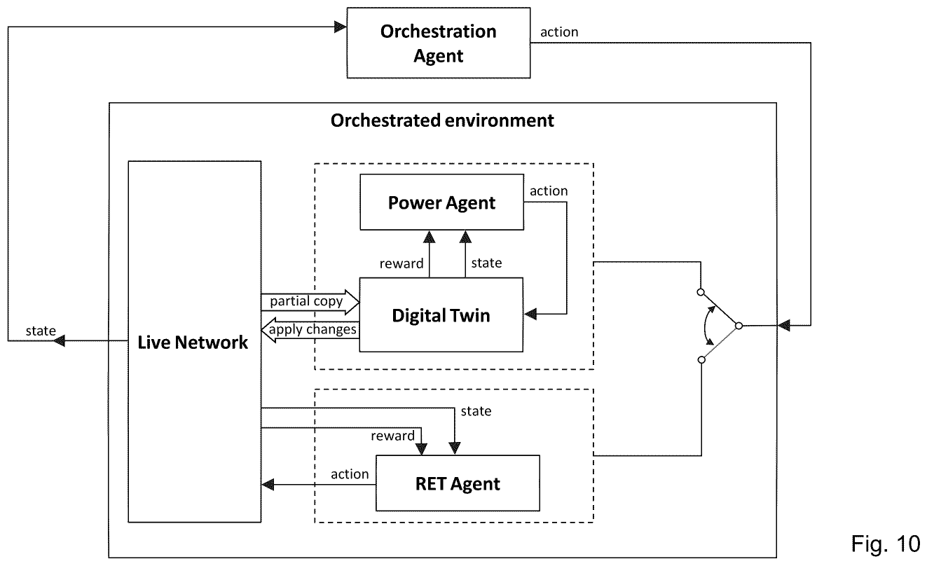

Two example implementation architectures for implementing the methods disclosed herein are illustrated at FIGS. 7 and 10. It will be appreciated that in the illustrated architectures, the optimization Agents operate at cell level, while the orchestration node operates at cluster level. In each figure, the orchestrated environment consists of the two optimization Agents described above. The methods disclosed herein are implemented by the orchestration node (illustrated as “Orchestration Agent”), and via the automatic switching between the power agent and the RET optimization agent.

FIG. 7 illustrates the RL approach to generating a prediction in step 420 of the method 400, and FIG. 10 illustrates the SL approach.

Referring initially to FIG. 7, in the RL approach as implemented in the present example, the orchestrator node is running a deep Q-learning RL Agent capable of learning when each optimization Agent, either the RET agent or the power agent, is the most suitable one to use at every iteration, while continuing to learn through a controlled exploration. The general block diagram of the example implementation based on this approach is illustrated in 7. This RL agent has the following peculiarities:

State definition (representation of the state of the environment): The state may in some examples be set up to contain as few features as possible. A light state definition accelerates the learning process, and this is an advantage in the present example because the orchestration RL Agent operates as an outer loop on top of the optimization Agents, and a single iteration of the outer loop might require multiple iterations of the inner loops (e.g., one step of the orchestration agent might imply a full offline power optimization campaign, or a single RET optimization step). The state may contain the action applied in the previous iteration plus the KPIs impacted by both optimization agents. In this particular case, the following features may be included to define the state:
DL quality level, which can be defined as the average DL user throughput. Alternatively, it is possible to use DL spectral efficiency, DL Channel Quality Indicator (CQI), DL SINR, Reference Signal Received Quality (RSRQ) or geometry factor.
DL coverage level, which can be defined as the ratio of users with Reference Signal Received Power (RSRP) over a certain threshold.
Transmitted energy level, which can be defined as the average DL transmit power over the measured time.
Previous action taken (for example, 0 meaning the RET Agent was selected and 1 meaning the power agent was selected).
Average reward obtained from one or more optimization agents in the previous iteration.

If the training time is not an issue, the next two additional features may also be included in the state (this will increase training time for the RL orchestration Agent but may also increase accuracy):
Average cell congestion level.
Ratio of cells with changes in the previous action.

As there is a unique agent (the RL orchestration agent implemented by the orchestration node) orchestrating the operation of all optimization Agents per cell, all previous KPIs may be aggregated at cluster level, to produce just one value per KPI for the cluster of cells to optimize.

Reward definition (measure of performance of the communication network): The reward should indicate how suitable the selected optimization Agent was in terms of improved performance during the last iteration. In one example, a score consisting of a weighted sum of the improvements in selected normalized KPIs aggregated at cluster level. In the present example it is proposed to use the same three initial KPIs as for the state definition: DL quality level, DL coverage level and transmitted energy level. In some examples, other KPIs such as energy expenditure may also be included in the score. Again, a single reward value may be provided per iteration for the whole cluster of cells to optimize. The weights for the KPIs can be different, and can be defined according to design preferences, for example to give more relative importance to some KPIs over others. Another option is to compute the KPIs as a weighted average from all cells in the cluster, using the traffic or any other metric as the weighting factor. This facilitates satisfying particular customer requests, for example by weighting cells based on commercial criteria.

Action definition (selection of an optimization Agent): two possible actions are defined:
0: Run one iteration of RET optimization agent.
1: Run one iteration of power optimization agent.

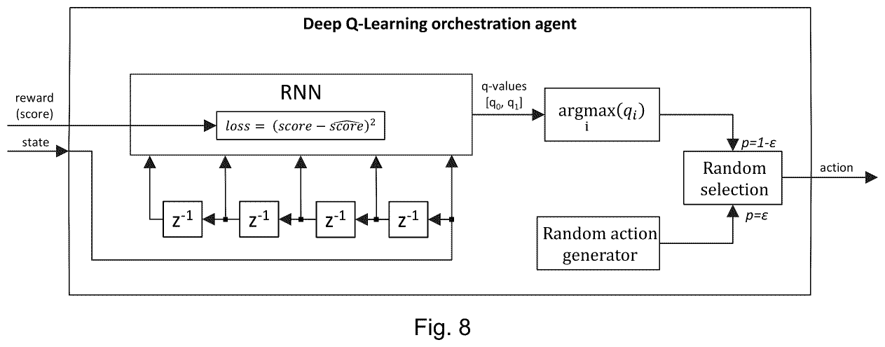

FIG. 8 shows a block diagram of the orchestration node based on deep Q-learning RL and implemented using an RNN. In the figure, the blocks labeled as z⁻¹ represent delay modules that produce an output that applies a one-iteration delay to the input. An important difference with respect to standard implementations of the Q-learning algorithm is that in this case the q-values are obtained from the RNN. It will be appreciated that in this case the q-values contain the expected reward (or score) associated with running the following iteration with each optimization agent, i.e., q₀ is the expected reward if the RET optimization agent is selected, and q₁ is the expected reward if the power optimization agent is selected.

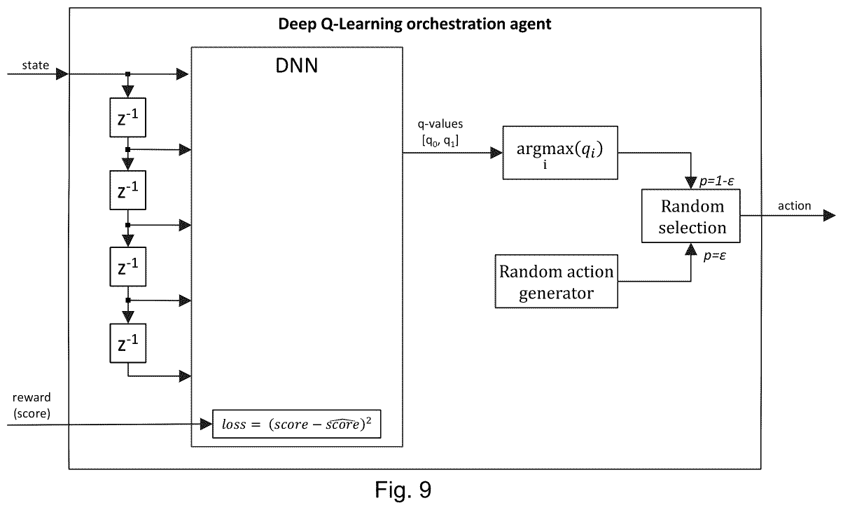

At every iteration, a forward/backward propagation step is carried out to train the RNN, with the target of minimizing the square of the residuals between the predicted scores and the actual scores measured after every action. An RNN is particularly suitable for this problem because it captures the temporal trends of the agents. Five consecutive samples of the state are considered in the example of FIG. 8, although a different number could be used: smaller for faster learning, or larger for higher accuracy. The rest of blocks in the diagram are known from standard Q-learning implementations: selection of the action with the highest associated q-value, and epsilon greedy policy to allow exploration. Experience replay may also be used to accelerate the training of the RNN. As discussed above, the RNN can be replaced with a regular DNN, considering the KPIs and actions associated with a predefined number of previous steps as input features, or considering actions as well as the mean and standard deviation of the KPIs associated with a predefined number of previous steps as input features. Such an example is illustrated in FIG. 9.

In some examples, and for a first iteration, dummy KPI values of −1 can be added as inputs associated with the non-existing previous states in the four initial iterations. The RNN will identify these special states if they are not used in any other situations. This can be ensured for example if the KPIs that form the state are normalized in the range [0,1].

The implementation discussed above permits fast initial offline learning using a simulator. The trained model is then ready to be used in a live network, from which it can continue learning while avoiding the erratic behavior typically associated with the initial learning steps in RL.

There are additional operational aspects that can be included, for example exploiting the possibilities offered by an off-policy RL algorithm, such as Q-learning. In one example, it is possible to force a minimum number of consecutive iterations with a certain optimization Agent. The orchestrator agent might alone have come to this selection, but the off-policy property of the Q-learning algorithm allows the orchestrator agent to learn, even from decisions which it did not make. This may be interesting for the RET optimization agent, which requires more iterations to converge. In the illustrated example, a minimum of 3 consecutive iterations could be a reasonable restriction for the RET agent.

In another example, it is possible to prevent a certain agent from running more than once consecutively, and also prevent it from running again for a minimum number of iterations, or until certain target KPIs (e.g., coverage or quality) have varied sufficiently. Again, the orchestration alone might make this decision, but it can nonetheless learn from the decision, as discussed above. This may be particularly interesting for the power optimization agent, which is a one-shot optimizer, and is not intended to be run repeatedly unless something else has changed between executions.

In further examples, as an alternative to using a simulator, it is possible to carry out the offline learning using recorded data from real networks in which orchestration was manually performed based on human decisions.

One of the advantages offered by the methods proposed herein is explainability, that is enabling end users and/or customers to understand the reasoning behind the decision made by the orchestrator node. In the case of the orchestration approach based on RL as in the above implementation example, the explanation of the decision depends upon whether that decision was made as a consequence of fulfilling a precondition or on the basis of a proposal made by the RL orchestration agent running in the orchestration node. If the decision is made as a consequence of fulfilling a precondition, this is determined by user input to define the precondition, for example forcing at least three consecutive RET optimization iterations. Fulfillment of the precondition is detected by the algorithm and can be exposed to the end user. If the action was determined by the RL agent, then it is possible to show the expected reward associated with each potential action, together with the individual KPIs that define the reward. Assuming the reward formula is accessible to the users, it is possible for them to understand the contribution of each KPI to the reward of the two (or more) possible actions.

Referring now to FIG. 10, in the SL approach as implemented in the present example, the orchestrator node estimates the performance improvement (or score) for both the power and the RET optimization agents at every iteration using SL and selects the one with the highest estimated value as the action to perform in the next iteration, as depicted in FIG. 10.

In a similar manner to the reward discussed above, the score estimated by the orchestrator node comprises a weighted sum of the improvements in selected normalized KPIs aggregated at cluster level. In the present example it is proposed to use the same three KPIs as for the RL example above. In some examples, other KPIs such as energy expenditure may also be included in the score. The weights for the KPIs can be different, and can be defined according to design preferences, for example to give more relative importance to some KPIs over others. Another option is to compute the KPIs as a weighted average from all cells in the cluster, using the traffic or any other metric as the weighting factor. This facilitates satisfying particular customer requests, for example by weighting cells based on commercial criteria. The proposed KPIs are:
DL quality level, which can be defined as the average DL user throughput. Alternatively, DL spectral efficiency, DL CQI, DL SINR, RSRQ or geometry factor may be used.
DL coverage level, which can be defined as the average number of users with RSRP over a certain threshold.
Transmitted energy level, which can be defined as the average DL transmit power over the measured time.

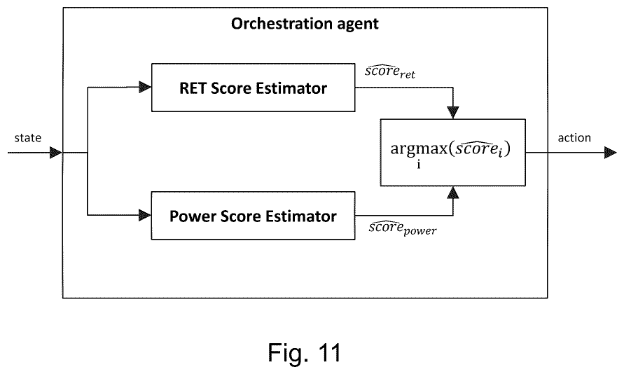

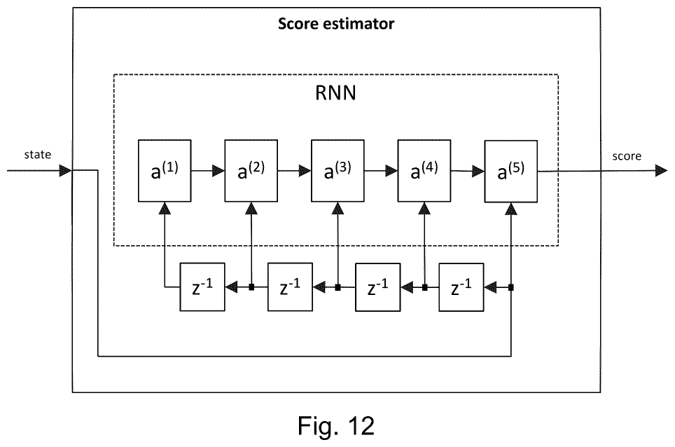

The module within the orchestration node that estimates the score is referred to in the present example as a score estimator. As illustrated in FIG. 11, in the present example the orchestration node is running two score estimators, one for each of the optimization agents being orchestrated. An example score estimator using a RNN is illustrated in FIG. 12. The input to the score estimator in the present example comprises the same features as are used to define the state for the approach based on RL discussed above. For this reason, the set of input features is referred to as “state” in FIGS. 10, 11 and 12.

The example score estimator illustrated in FIG. 12 comprises an RNN, which is operable to capture the temporal trends of the optimization Agents. Five consecutive samples of the “state” (that is the input) are considered in the example of FIG. 12, although a different number could be used. It will be appreciated that the main difference between the RNN illustrated in FIG. 12 and that illustrated in FIG. 8 is that the RNN of FIG. 12 only predicts the score for one optimization Agent, and the orchestration node consequently comprises a separate RNN per optimization Agent. In the orchestration node of FIG. 8, the same RNN predicts the scores for all optimization Agents.

As discussed above, the RNN can be replaced with a DNN, considering the KPIs and actions associated with a predefined number of previous steps as input features, or considering actions as well as the mean and standard deviation of the KPIs associated with a predefined number of previous steps as the features. As in the RL based approach discussed above, in the case of initial iterations of the orchestration node, dummy KPI values, for example of −1, can be added as inputs associated with the non-existing previous states. The RNN or DNN can identify these special states if they are not used in any other situations. This can be achieved for example if the KPIs that form the state are normalized in the range [0,1].

The SL based approach may be particularly suitable when one of the optimization Agents can provide a prediction of expected performance improvement associated with its selected action in advance. In that case, the score estimator for that optimization Agent can be replaced by provision of the prediction made by the optimization Agent. In the present example, this is the case for the power optimization agent, which uses a digital twin that is capable of predicting KPIs following implementation of selected actions with no need to interact with the live network. In this case, the RNN used to predict the performance improvement obtained from the RET optimization agent could be compared to prediction from the digital twin used for power optimization.

The one or more RNNs or DNNs of the score estimators can be trained offline using simulations or offline records from live network data, and the training could be updated periodically once the orchestration node is connected to the live network to optimize. The data used for training should however maintain some temporal sequence. It will be appreciated that the use of one or more preconditions to force certain selections (minimum consecutive selections, threshold KPI values or changes etc.) can be adopted for the SL approach as explained in greater detail with reference to the RL approach.

Explainability for the orchestration node based on supervised learning is very similar to that for the approach based on RL. If the decision is made as a consequence of fulfilling a precondition, this is determined by user input to define the precondition, for example forcing at least three consecutive RET optimization iterations. Fulfillment of the precondition is detected by the algorithm and can be exposed to the end user. If the action was determined by the SL predictions, then it is possible to show the expected reward associated with each potential action, together with the individual KPIs that define the reward. Assuming the reward formula is accessible to the users, it is possible for them to understand the contribution of each KPI to the reward of the two (or more) possible actions.

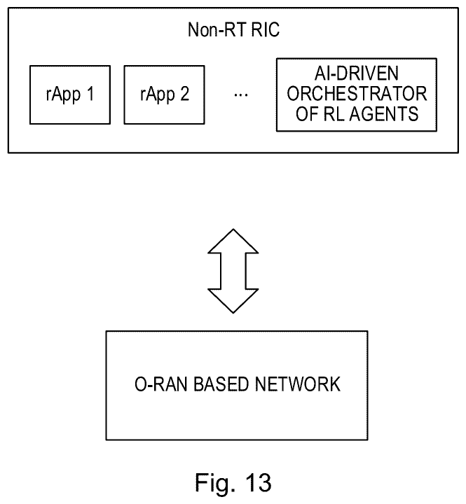

In an Open-RAN implementation, it will be appreciated that the orchestration node of the present disclosure can be implemented as a single RAN automation application (rApp) in the Non Real Time (Non-RT) Radio Intelligent Controller (RIC) located in the Service Management and Orchestration (SMO) Framework of the O-RAN architecture. This is shown in FIG. 13 and can be used as a standalone app and/or the results can be used by other rApps

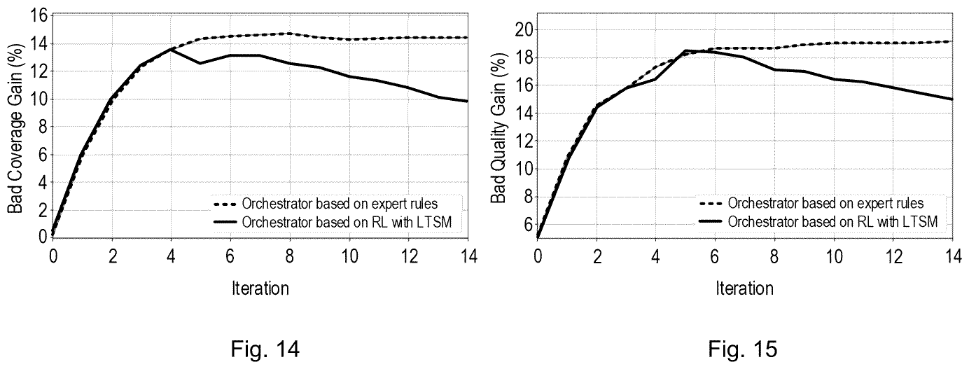

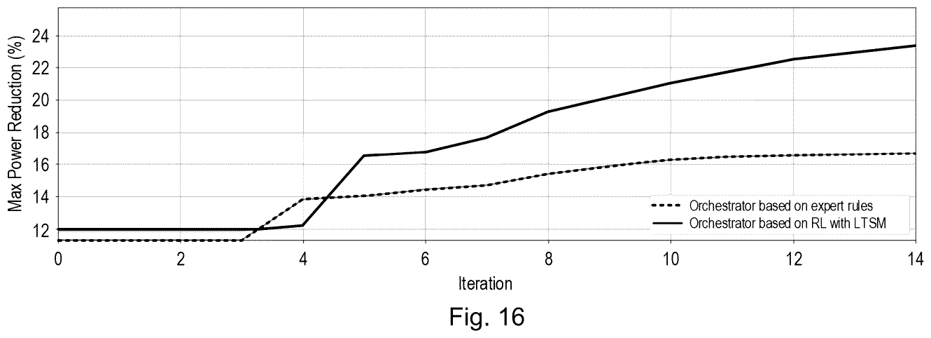

FIGS. 14 to 16 illustrate results of comparative testing of the above discussed implementation examples of methods according to the present invention, and the manual orchestration experiment described at the beginning of the detailed description section of the present specification. It can be seen from FIGS. 14 and 15 that up to approximately 5 iterations, the orchestration provided by examples of the present invention matches the expert driven orchestration gains in coverage and quality. Considering power reduction, as illustrated in FIG. 16, the orchestration provided by examples of the present invention exceeds that provided by expert driven orchestration from the 5^{th} iteration onwards.

It will be appreciated that the above discussed use case including an optimization agent for RET and an optimization agent for maximum DL transmit power is merely one example of how example methods according to the present disclosure may be put into practise. Examples of other operational parameters whose management may be orchestrated using the methods disclosed herein include PO nominal PUSCH, CRS power boost (or CRSgain), A3offset, A5threshold, A5offset, cellindividualoffset, alpha, etc.

Examples of the present disclosure thus propose an automatic method that enables coordination of two or more optimization agents, which agents may be based on RL and tune different operational parameters that have an impact on the same network KPI or KPIs. The methods provide decisions as to the most suitable optimization agent to use at every iteration, with a view to maximizing improvement of a performance measure based on network KPIs.

The orchestration of different optimization Agents is carried out by an orchestration node, which may use Reinforcement or Supervised Learning, and which may be implemented using DNNs or advantageously RNNs. The orchestration node learns, either via RL or SL, to select the optimal agent to be initiated for each iteration, so that an optimal sequence of agent selections is implemented, ensuring favorable progression of the network performance measure. In some examples, certain selections may be forced when circumstances fulfil one or more preconditions. In RL, this is facilitated by using an off-policy RL agent algorithm, such as Q-Learning. Examples of these “forced” actions may include not permitting two consecutive power optimization executions, or forcing a minimum number of consecutive RET optimization executions.

Learning may be achieved using past experience and, in the case of RL, exploration during the initial phases. As this may lead to suboptimal performance, an RL orchestration agent may be pre-trained with a simulator, or at least with statistics from previous trials where the combined use case of optimization agents is applied to a real network, for example based on manual decisions or expert rules.

Example methods according to the present disclosure leverage potential from the optimization agents, boosting the performance over solutions that rely on expert skills, which might result sub-optimal. In addition, the methods are fully automated, requiring no human intervention and thus facilitating deployment, scaling and adaptability. Methods according to the present disclosure also offer explainability, as predicted scores are estimations of the performance improvement that will be obtained when using the available agents. This may be particularly useful for interacting with customers, whose confidence is increased when they can understand the reasons behind the decisions made by solutions, especially based on ML. Example methods disclosed herein can also be integrating into an even higher global orchestrator, as modular scaling is supported by the methods. For example, individual orchestration agents may be viewed as optimization agents coordinated by a higher-level orchestration agent. This higher-level orchestration agent could be based on methods disclosed herein, or even on any other external solution, such as a machine reasoning-based orchestration platform. The provided scores can be considered as universal measurements that could be compatible as input to those external solutions.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims or numbered embodiments. The word “comprising” does not exclude the presence of elements or steps other than those listed in a claim or embodiment, “a” or “an” does not exclude a plurality, and a single processor or other unit may fulfil the functions of several units recited in the claims or numbered embodiments. Any reference signs in the claims or numbered embodiments shall not be construed so as to limit their scope.

1.-29. (canceled)

30. A performed by an orchestration node of a communication network for orchestrating management of a plurality of operational parameters in an environment of the communication network, wherein the respective operational parameters are managed by respective Agents, wherein at least one performance parameter of the communication network is operable to be impacted by each of the operational parameters, wherein the method comprises:
obtaining a representation of a state of the environment;
using a Machine Learning (ML) process and the obtained state representation, generating a prediction of which of the Agents, if allowed to execute within the environment respective actions selected by the respective Agent for management of the respective operational parameters, will result in the greatest increase of a performance measure for the communication network;
selecting one of the Agents on the basis of the prediction; and
initiating execution by the selected Agent of the action selected by the selected Agent.

31. A method as claimed in claim 30, wherein generating the prediction of which of the Agents is based on an indication of which of the Agents was selected during a previous iteration of the method.

32. A method as claimed in claim 30, wherein generating the prediction comprises, using an ML model, predicting respective expected values of the performance measure if the respective Agents are allowed to execute within the environment respective actions selected by the respective Agent for management of the respective operational parameters.

33. A method as claimed in claim 30, wherein predicting respective expected values of the performance measure is based on the following:
the obtained state representation as input to the ML model; and
current values of trainable parameters of the ML model.

34. A method as claimed in claim 32, wherein the ML model comprises at least one of the following: a Deep Neural Network (DNN); and a Recurrent Neural Network (RNN).

35. A method as claimed in claim 30, wherein generating the prediction is further based on a representation of a state of the environment obtained during a previous iteration of the method.

36. A method as claimed in claim 35, wherein:
the RL process includes a Deep Neural Network (DNN); and
generating the prediction comprises, using the DNN, the obtained state representation, and the state representation obtained during the previous iteration of the method, predicting respective expected values of the performance measure if the respective Agents are allowed to execute within the environment the respective actions selected by the respective Agents for management of the respective operational parameters.

37. A method as claimed in claim 35, further comprising, when the representation of the state of the environment during a previous iteration of the method is not available, generating an initial state representation of the environment, on which generating the prediction is further based, wherein values for parameters of the initial state representation are set outside of a normalized envelope for values of corresponding parameters in the obtained state representation.

38. A method as claimed in claim 30, wherein:
the ML process is a Reinforcement Learning (RL) process; and
generating the prediction comprises, using a single ML model and a single inference, predicting respective expected values of the performance measure if the respective Agents are allowed to execute within the environment respective actions selected by the respective Agents for management of the respective operational parameters.

39. A method as claimed in claim 38, wherein predicting respective expected values of the performance measure is based on the following:
the obtained state representation as input to the single ML model; and
current values of trainable parameters of the single ML model.

40. A method as claimed in claim 30, wherein the ML process is a Reinforcement Learning (RL) process and the method further comprises:
obtaining a value of the performance measure for the communication network;
adding the obtained state representation, the selected Agent, and the obtained value of the performance parameter to an experience buffer; and
based on the experience buffer, updating trainable parameters of an ML model used to generate the prediction.

41. A method as claimed in claim 30, wherein:
the ML process is a Supervised Learning (SL) process; and
generating the prediction comprises, using dedicated ML models for the respective Agents, predicting respective expected values of the performance measure if the respective Agents are allowed to execute within the environment respective actions selected by the respective Agents for management of the respective operational parameters.

42. A method as claimed in claim 41, wherein predicting respective expected values of the performance measure is based on the following:
the obtained state representation as input to the respective dedicated ML models; and
current values of trainable parameters of the respective ML models.

43. A method as claimed in claim 30, wherein:
the ML process is a Supervised Learning (SL) process; and
generating the prediction comprises obtaining, from at least one of the Agents, respective expected values of the performance measure if the at least one Agent is allowed to execute within the environment respective actions selected by the at least one Agent for management of respective operational parameters.

44. A method as claimed in claim 30, wherein selecting one of the Agents on the basis of the prediction comprises selecting the Agent predicted to result in a greatest increase of the performance measure, unless a precondition for an alternative selection is fulfilled, wherein the precondition comprises a maximum or minimum limit on the number of times an Agent may be selected consecutively.

45. A method as claimed in claim 30, wherein the performance measure comprises a weighted combination of performance parameters for the communication network.

46. A method as claimed in claim 30, wherein one or more of the following applies:
at least one of the operational parameters is managed at cell level, each cell having a dedicated managing Agent for the parameter within the cell; and
at least one of the operational parameters is managed at environment level.

47. A method as claimed in claim 30, wherein one or more of the following applies:
the environment comprises a cluster of cells; and
the plurality of operational parameters include remote electronic tilt and maximum downlink transmission power.

48. An orchestration node configured to orchestrate management of a plurality of operational parameters in an environment of a communication network, wherein each of the operational parameters is managed by a respective Agent, wherein at least one performance parameter of the communication network is operable to be impacted by each of the operational parameters, and wherein the orchestration node comprises:
processing circuitry configured to:
obtain a representation of a state of the environment;
using a Machine Learning (ML) process and the obtained state representation, generate a prediction of which of the Agents, if allowed to execute within the environment respective actions selected by the respective Agent for management of the respective operational parameters, will result in the greatest increase of a performance measure for the communication network;
select one of the Agents on the basis of the prediction; and
initiate execution by the selected Agent of the action selected by the selected Agent.

49. The orchestration node of claim 48, wherein the processing circuitry is configured to generate the prediction based on predicting, using an ML model, respective expected values of the performance measure if the respective Agents are allowed to execute within the environment respective actions selected by the respective Agent for management of the respective operational parameters.
